(19) United States
(12) Patent Application Publication
(10) Pub. No.: US 2015/0313200 A1
(43) Pub. Date: Nov. 5, 2015

(54) FISHING ROD AND REEL CARRYING CASE SYSTEM

(71) Applicant: Angler's-Friend, LLC, Merriam, KS (US)

(72) Inventors: Corben D. Tannahill, Merriam, KS (US); David B. Tannahill, Merriam, KS (US)

(21) Appl. No.: 14/678,811

(22) Filed: Apr. 3, 2015

Related U.S. Application Data
(60) Provisional application No. 61/974,839, filed on Apr. 3, 2014.
(60) Provisional application No. 62/105,594, filed on Jan. 20, 2015.

(51) Int. Cl. A01K 97/08

(52) U.S. Cl. CPC A01K 97/08

(57) ABSTRACT

A storage and carrying case for fishing equipment is provided. The case can include first and second shell halves, each having an interior compartment defined by a plurality of walls. The shell halves may be hingedly connected along longitudinal ends to allow one shell half to pivotally open and close with respect to the other shell half. The case can also include locking means on the front exterior walls of the case to secure the shell halves together. Inside the interior compartments of each shell have may be various storage compartments and storage regions. Fishing rod storage compartments may be placed along the longitudinal walls of each compartment. Reel storage regions permanently or temporarily secured to the interior walls of the interior compartments may be selectively positioned to allow storage of attached rods and reels. General storage compartments may also be placed between reel regions for storage of various fishing equipment.

### CROSS-REFERENCE TO RELATED APPLICATIONS

This application claims priority to U.S. Provisional Patent Application Ser. No. 61/974,839, filed on Apr. 3, 2014, to Corben D. Tannahill and David B. Tannahill, entitled “Storage and Carrying Case for Sporting Equipment, Fishing Tackle and Fishing Rods having Attached Reels,” currently pending, the entire disclosure of which is incorporated herein by reference, and U.S. Provisional Patent Application Ser. No. 62/105,594, filed on Jan. 20, 2015, to Corben D. Tannahill and David B. Tannahill, entitled “Rod Pocket and Improved Storage and Carrying Case,” currently pending, the entire disclosure of which is incorporated herein by reference.

### FIELD OF THE INVENTION

The present invention relates to a system for storing and carrying devices such as sporting equipment that is used conjunction with fishing, hunting, archery, and the like. The present invention is specifically directed toward portable storage and carrying cases for fishing equipment that provide convenient, protective storage and portability of various fishing tackle combined with multiple fishing rods, and reels and other equipment.

### BACKGROUND OF THE INVENTION

Storage and carrying cases for sporting equipment commonly fail to adequately secure and contain the equipment stored therein while the case is transported and stored. Additionally, such cases are commonly bulky, inefficient, and difficult to handle. In particular, fishing storage and carrying cases commonly fail to contain, secure and protect multiple fishing rods and reels. During transport, fishing rods and reels are unwieldy and easily damaged. Attached fishing line presents challenges of entanglement with other fishing equipment and other enclosed items during storage or transport. Fishing rods generally must be split into multiple pieces for transport and therefore it is important that the pieces remain together and contained during transport so that the angler does not have difficulty assembling the fishing rod.

Furthermore, anglers desire minimal setup time upon arrival at a fishing site, preferring the reel and line to be attached to the rod with the line readied for use. The disproportionate bulge of an attached reel upon a rod, in particular the bulge from a carriage of an open face spinning reel, prevents presently known cases from having an appealing and functional shape that is advantageous for packing, shipping, and transporting.

Many anglers also prefer more than one rod and reel readied for use for various reasons. It may be an advantage to have differentiating equipment for different fish species and for different fishing environments, conditions and strategies. It may also be advantageous to have multiple readied rod and reel combinations when multiple anglers are present.

Fishing storage and carrying cases commonly require partitions between the rod/reel storage and the tackle storage that make it difficult to access the tackle storage without removing the rod and/or reel. Furthermore, storage and carrying cases for fishing equipment are commonly oddly shaped to accommodate differing reel sizes, have inadequate storage capacity, and are unable to effectively and securely store multiple attached rod/reel combinations.

Accordingly, a need exist for a storage and carrying case that is compact, portable, easily handled, and that can adequately store and carry multiple fishing rods and reels (attached or unattached) along with other fishing equipment such that the rods, reels and equipment remain protected, secured and undamaged during the transportation and storage.

### SUMMARY OF THE INVENTION

One objective of the present invention is to provide a portable storage and carrying case for fishing equipment, and other sporting equipment that can carry multiple fishing rods and reels, both attached and unattached, in a functional, easily transportable case. Another object of the present invention is to provide a securing device for fishing rods of various sizes that may adequately secure the rod while conserving space in the storage and carrying case. A further object of the present invention is to provide a storage and carrying case that has selectively moveable and adaptable storage compartments for storing several different types of fishing rods, reels and other fishing equipment.

In one embodiment of the present invention, a storage and carrying case comprises two half shells, a first shell half with a first interior compartment and a second shell half with a second interior compartment. The two shell halves may be hingedly connected along adjacent longitudinal sides allowing the case to transition from a closed position to an open position. Exterior closure components, such as latches or buckles, may be connected to front panels of each of the shell halves thereby allowing the case to be secured in the closed position when desired by the user.

Within each interior compartment of the shell halves may be various storage compartments and regions, including rod storage compartments, reel storage regions, and general/tackle storage compartments. The various storage compartments may be permanently defined in or secured to the interior walls of the first and second interior compartments or they may be temporarily secured to the interior walls such that they may be selectively positioned (or repositioned) by the user.

The rod storage compartments or rod pockets may be narrow, longitudinally-oriented storage devices that are positioned along the longitudinal sides of the interior compartments. Each interior compartment may contain one, two or more rod pockets, or no rod pockets at all. The rod pockets may be defined in a lining disposed on the interior walls of the interior compartments or they may be secured to the interior walls of the interior compartments using commonly available securing means such as Velcro® or similar hook and loop fasteners, for example. Each rod pocket may include upper and lower rod holders or slots defined within the walls of the rod pocket for holding a portion of a stored fishing rod. In one embodiment, the upper rod holder is slightly offset and above the lower rod holder, which is separated from the upper rod holder by a dividing wall. Such a configuration allows for more efficient use of storage space in each interior compartment. Each rod holder may also include a retaining lip that helps hold the fishing rod (or a portion of the fishing rod) in a secured position. To further secure the rods (or portions of the rods) in position, the rod pockets may include one or more containment straps selectively spaced across the longitudinal length of the rod pocket. One end of the containment strap may be fixedly secured to the rod pocket or wall of the corresponding interior compartment, while the opposing free end may contain a removable securing means, such as Velcro® or other similar hook and loop fasteners, which corresponds with, and may be attached to, opposing securing means located on or adjacent the rod pocket such that the containment strap spans across the opening of the upper rod holder, the lower rod holder, or both.

One or more fishing reel storage regions may be located within the interior compartments of both the first and second shell halves. The reel storage regions may be zones or spaces not physically defined. Alternatively, the reel storage regions may be defined within a liner disposed through the interior compartments or the reel storage regions may be fixedly or temporarily secured to the walls of the interior compartments. If temporarily secured, the securing means may be in the form of commonly available fasteners, such as Velcro® or similar hook and loop fasteners. The reel storage regions may be generally rectangular and may include an opening for receiving a fishing reel. The reel compartments may also include reel positioners that align and orient the reel within the reel storage region. To secure the fishing reels in the reel storage regions, containment straps, protective netting, fabric or other fastening means may be used. The reel storage regions may also be selectively movable such that the reel storage regions are positioned relative a corresponding rod pocket so as to allow storage of a fishing rod and attached reel within the case. Preferably, the reel compartments are positioned such that a reel storage region located in the first shell half does not superimpose a reel storage region located in the section shell half when the case in its closed position.

One or more general storage compartments for storing various fishing equipment (such as lures, bait, tools, hooks, etc.) may be located within the interior compartments of both the first and second shell halves. Similar to the reel storage regions, the general storage compartments may be defined within the liner of the interior compartments or may be secured to the walls of the interior compartments using temporary or permanent securing means. Each general storage compartment may include a plurality of sidewalls that define an opening in which storage containers (such as tackle boxes) may be placed. Alternatively, various fishing equipment may be placed directly into the general storage compartments. The compartments may include a lid or other means for securing contents within the general storage compartments, such as containment straps, protective netting or fabric, or other common fastening means. The general storage compartments are located transversely between the walls (and adjacent rod pockets) of the interior compartments and selectively positioned such that they do not interfere with the placement of reels within the reel storage regions when the case is closed.

Other aspects and advantages of the present invention will be apparent from the following detailed description of the preferred embodiments and the accompanying drawing figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is an end perspective view of a storage and carrying case illustrating interior compartments of a first shell half and a second shell half in accordance with one embodiment of the present invention;

FIG. 2 is a front elevation view of a storage and carrying case in accordance with one embodiment of the present invention;

FIG. 3 is a top plan view of the storage and carrying case of FIG. 2;

FIG. 4 is an end elevation view of the storage and carrying case of FIG. 2 illustrating the case in a closed position;

FIG. 5 is an end elevation view of a storage and carrying case illustrating the case in an opened position in accordance with one embodiment of the present invention;

FIG. 6 is a top perspective view of a rod storage compartment or rod pocket in accordance with one embodiment of the present invention;

FIG. 7A is an end elevation view of a rod pocket illustrating securing means and a containment strap spanning across an upper rod holder slot in accordance with one embodiment of the present invention;

FIG. 7B is an end elevation view of a rod pocket illustrating securing means and a containment strap spanning across a lower rod holder slot in accordance with one embodiment of the present invention;

FIG. 7C is an end elevation view of a rod pocket illustrating securing means and a containment strap spanning across both an upper rod holder slot and a lower rod holder slot in accordance with one embodiment of the present invention;

FIG. 8 is a top plan view of a storage and carrying case illustrating a rod storage compartment or rod pocket comprising non-continuous rod pocket components in accordance with one embodiment of the present invention;

FIG. 9 is a top plan view of a storage and carrying case illustrating rod pockets and reel storage regions when the case is in a closed position in accordance with one embodiment of the present invention;

FIG. 10 top plan view of the storage and carrying case of FIG. 9 illustrating the rod pockets and reel storage regions when the case is in an opened position;

FIG. 11A is a sectional end elevation view of the storage and carrying case of FIG. 4 illustrating rod storage compartments and a reel storage region in the interior of the case;

FIG. 11B is a sectional end elevation view of the storage and carrying case of FIG. 4 illustrating a single fishing rod and attached reel stored in the interior of the case;

FIG. 11C is a sectional end elevation view of the storage and carrying case of FIG. 4 illustrating multiple fishing rods and attached reels stored in the interior of the case;

FIG. 12 is a diagrammatic view of a storage and carrying case with general storage compartments in accordance with one embodiment of the present invention; and

FIG. 13 is an elevation view of a storage and carrying case with straps and a lighting device in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

Referring to the figures, the present invention is generally directed toward a storage and carrying case 10 that may be generally adapted for storing and carrying fishing rods 12, fishing reels 14 and/or other fishing equipment. Case 10 may also be adapted for carrying and storing several other types of sporting equipment, such as firearms, hunting equipment, archery equipment and the like. Case 10 may be constructed from any number of suitable materials, including polymers such as acrylonitrile butadiene styrene (ABS) or ethylene-vinyl acetate (EVA), sheet metal and various other metals, wood, plywood, various dimensional plastics such as PVC lumber and PVC sheets, molded plastics or the like.

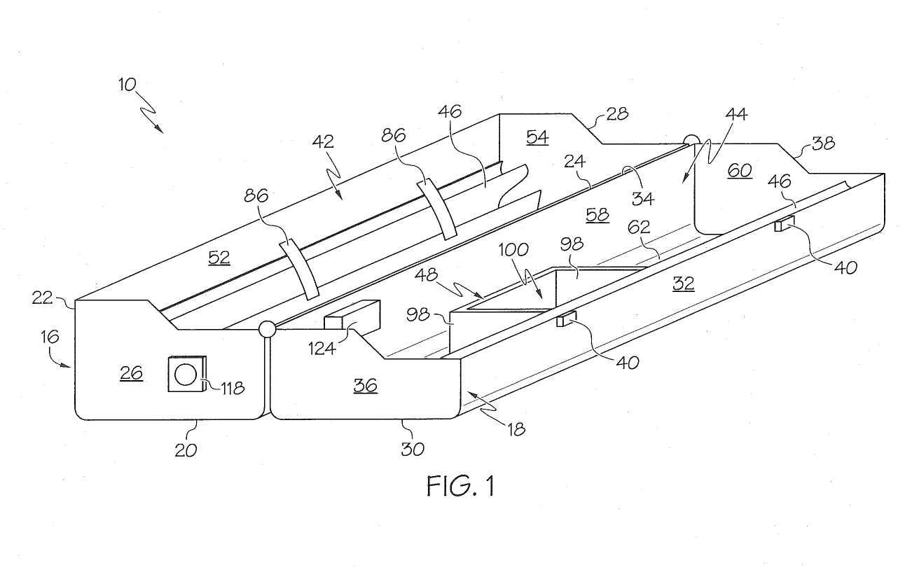

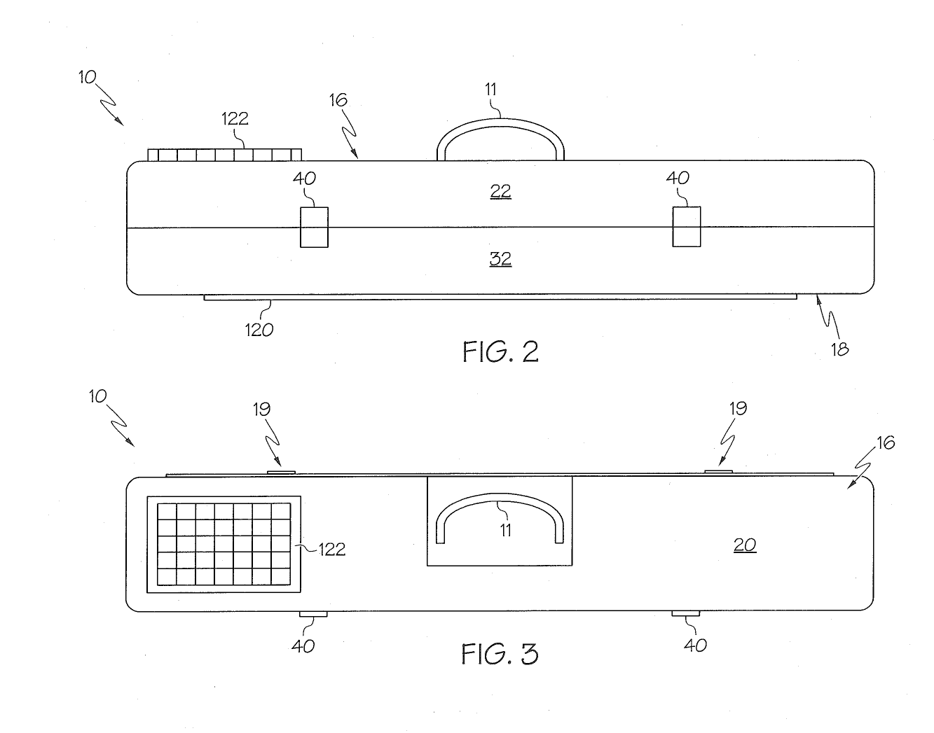

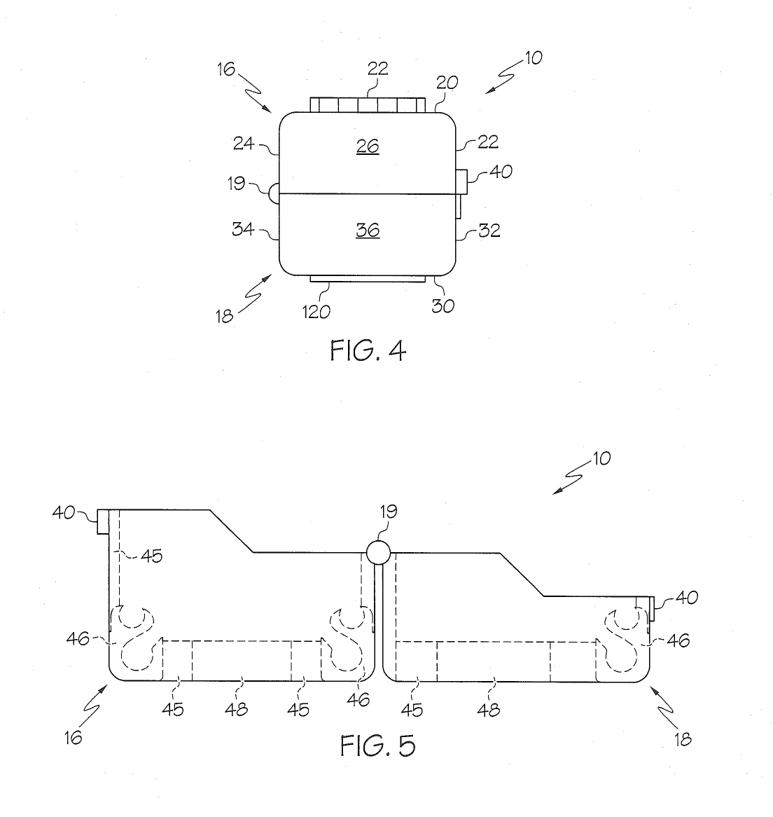

Case 10 may include two half shell sections, an upper section or first shell half 16 and a lower section or second shell half 18 as best shown in FIG. 1. Both shell halves 16 and 18 may be similar or identical in terms of size and shape, as shown in FIGS. 2 and 4, according to one embodiment of the invention. The shell halves 16 and 18 may also be slightly different, such as having different overall heights, as shown in FIGS. 1 and 5, according to one embodiment of the present invention. The first shell half 16 may include a top exterior panel 20, a front exterior panel 22, a rear exterior panel 24 and end exterior panels 26 and 28 as best shown in FIG. 1. Similarly, the second shell half 18 may include a bottom exterior panel 30, a front exterior panel 32, a rear exterior panel 34 and end exterior panels 36 and 38. The shell halves 16 and 18 may be longitudinally hinged together about the terminal edges of their respective rear panels 24 and 34 using common hinged fasteners, as shown in FIGS. 3, 4, and 5. The hinged connection allows the case 10 to transition from a closed position as shown in FIG. 4 to an opened position as shown in FIG. 5.

Case 10 may also include an exterior closure component 40 for securing the case 10 in the closed position. The exterior closure component 40 may comprise a zipper spanning the perimeter of the case 10, one or more latches, locks, buckles or other commonly known fasteners, which may be located on, and secured or attached to, the front exterior panels 22 and 32 of the shell halves 16 and 18, respectively and/or the end exterior panels 26 and 28 and 36 and 38 of the shell halves 16 and 18, respectively. The exterior closure component 40 may secure the first shell half 16 to the second shell half 18 when zipped, locked, latched, or buckled while not preventing separation of the shell halves 16 and 18 when unzipped, unlocked, unlatched, or unbuckled.

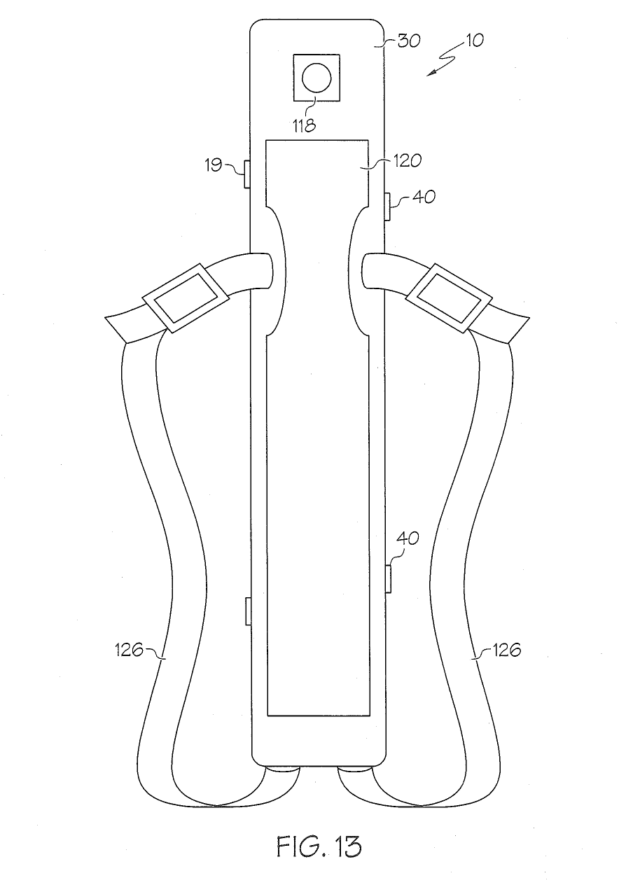

Case 10 may also include a handle 11 and/or carrying shoulder strap or straps 126 to assist a user in carrying and transporting the case 10. The shoulder strap(s) 126 may be connected to the case 10 by D-rings or similar device located on one of the exterior panels of the first shell half 16 and/or second shell half 18. To further assist in carrying the case 10, the exterior panels of the shell halves 16 and 18 may have padding 120 attached thereto constructed from EVA or other polymers, foam, plastic or the like. Case 10 may also contain lighting devices, such as an LED light, 118 in the exterior of the first and/or second shell halves 16 and/or 18 or first and/or second interior compartments 42 and/or 44, in accordance with one embodiment of the present invention. As shown in FIG. 13, the bottom exterior panel 30 of the second shell half 18 may contain a lighting device 118 such that it can illuminate the area in front of the user when the case 10 is worn on the user's back in a manner similar to a backpack. The lighting device 118 may also be mounted through the interior compartment 42 or 44 and first or second shell half 16 or 18 to provide illumination for both the interior and exterior of the case 10, according to one embodiment of the present invention. Case 10 may also contain a solar panel 122 attached to the exterior of the first or second shell halves 16 or 18, in accordance with one embodiment of the present invention. In such an embodiment, the case 10 may also include a battery 124 on the interior of the case 10 that may be charged by the solar panel 122 and used to provide a 12-volt DC power system for lighting and other uses.

The first and second shell halves 16 and 18 may each include respective interior compartments 42 and 44 used to store various equipment, including fishing equipment, in one or more storage compartments 46, 48 and 50 as described in greater detail below. First interior compartment 42 may be defined by longitudinal walls 52 that correspond to front and rear exterior panels 22 and 24, transverse walls 54 that correspond to end exterior panels 26 and 28 and bottom wall 56 that corresponds to top exterior panel 20. Similarly, second interior compartment 44 may be defined by longitudinal walls 58 that correspond to front and rear exterior panels 32 and 34, transverse walls 60 that correspond to end exterior panels 36 and 38, and a bottom wall 62 that corresponds to bottom exterior panel 30. Each interior compartment 42 and 44 may also include liner 45 made from polymers such as ethylene-vinyl acetate, extruded polyurethane, foam, fabric, plastic or the like as shown in FIG. 5. The liner 45 may provide greater protection and securement of the contents stored and carried in the case 10. In one embodiment, the liner 45 comprises a thin layer of padding to protect the contents in the case 10. In an alternative embodiment, the liner 45 may be configured to define various storage compartments 46, 48 and 50 within the interior compartments 42 and 44. The liner 45 may be secured to the interior walls 52, 54, 56, 58, 60 and/or 62 of the first and second interior compartments 42 and 44 using an adhesive or any other suitable securing means. The liner 45 may also fully or partially cover the interior compartments 42 and 44 of case 10. The configuration of the storage compartments 46, 48, and 50 within interior compartments 42 and 44 allow the case 10 to remain portable and compact while still storing and carrying multiple fishing rods, reels and other various fishing equipment.

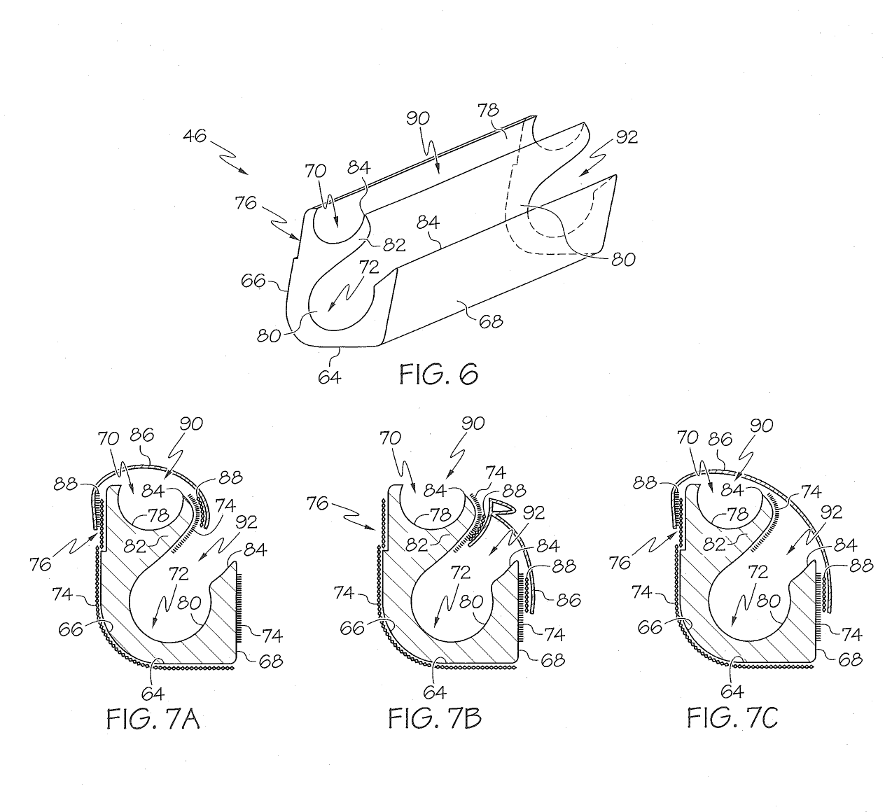

Referring now to FIGS. 6 through 7A-7C, the first and second interior compartments 16 and 18 may include one or more narrow longitudinal storage compartments or rod pockets 46 located along one or both of the longitudinal walls 52 and 58 of interior compartments 42 and 44, respectively. The longitudinal storage compartments or rod pockets 46 may be used to hold and store fishing rods 12. Alternatively, the rod pockets 46 may be used to store other sporting equipment such as archery equipment including arrows. The rod pockets 46 may be constructed from molded polyurethane, EVA, foam material, plastic, rubber, metal, wood or other suitable material, and may also be constructed from a material with buoyant properties in order to aid flotation of the case 10 when in water. The rod pockets 46 may also be used separately from case 10, such as mounted on a wall or boat, or inserted into a rod sock or similar device.

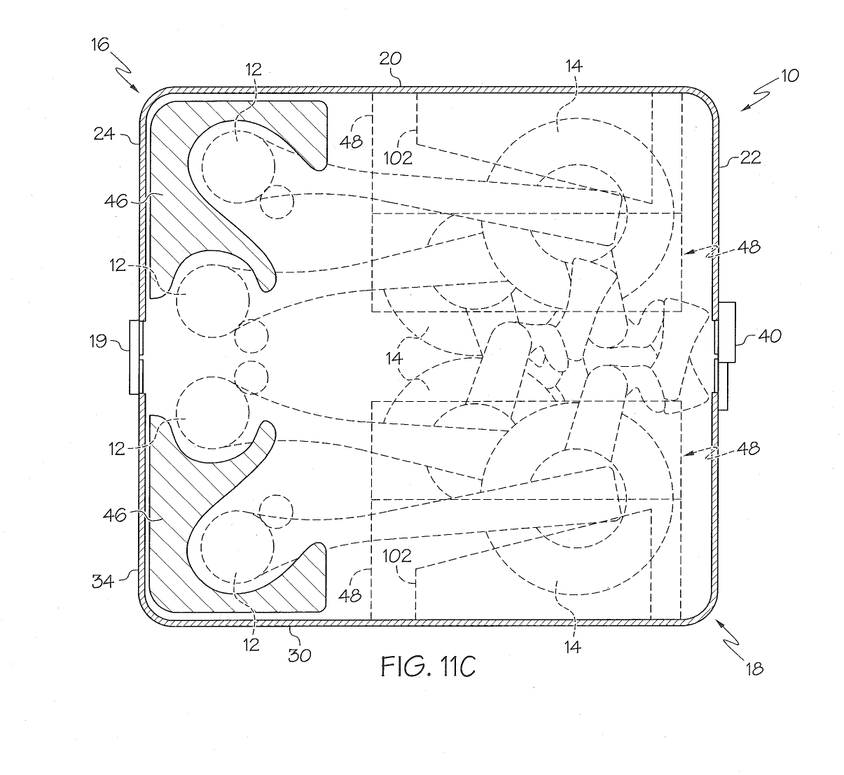

The rod pockets 46 may have an overall height that is generally similar to the height of the interior compartment 42 or 44, as shown in FIGS. 11A-11C, according to one embodiment. According to other embodiments, the rod pockets 46 may have a height less than the height of the interior compartment 42 or 44 as shown in FIGS. 1 and 5.

As best shown in FIGS. 6 and 7A-7C, the rod pockets 46 may include a base 64, an exterior outer sidewall 66, and exterior inner sidewall 68, an upper rod holder 70, and a lower rod holder 72. In alternative embodiments, the rod pocket 46 may be configured to include three or more rod holders. The base 64 and exterior sidewalls 66 and 68 define the lower exterior of the rod pocket 46 and may be configured to conform to the walls 52, 54, 56, 58, 60 and/or 62 of the interior compartments 42 and 44. As best shown in FIG. 1, the rod pockets 46 may be configured to be positioned generally flush against longitudinal wall 52 or 58 and span between transverse walls 54 and 60 in order to maximize the storage space of each of the interior compartments 42 and 44.

The rod pockets 46 may be temporarily or permanently secured to the walls of the first and second interior compartments 42 and 44 using various securing means. In one embodiment, the exterior outer sidewall 66 and/or base 64 of the rod pocket 46 may have securement means 74 affixed thereto (as best shown in FIGS. 7A-7C) that correspond to opposing securement means 74 located on the walls 52, 54, 56, 58, 60, and or 62 of the interior compartments 42 and 44 or located on the liner 45. Thus, the rod pocket 46 may be secured to the walls 52, 54, 56, 58, 60, and/or 62 or to the liner 45 by securing the corresponding securing means 74. The securement means 74 may consist of hook and loop fasteners, Velcro® or similar material. In an alternative embodiment, the rod pocket 46 may be permanently secured to interior compartments 42 or 44 by securing the exterior sidewall 66 and/or base 64 to the walls 52, 54, 56, 58, 60 and/or 62 of the interior compartments 42 and 44 using an adhesive or similar means. In another alternative embodiment, the rod pocket 46 may be secured to the liner 45 using an adhesive or similar means. In yet another embodiment, the rod pocket 46 may comprise part of the liner 45 such that the two are a continuous unitary piece. In yet another embodiment, the entire interior compartment 42 or 44, liner 45 and rod pocket 46 are formed or molded as a single unitary piece, such as from ABS, EVA or similar material. In yet another embodiment, the shell half 16 or 18, interior compartment 42 or 44, liner 45 and rod pocket 46 are formed or molded as a single unitary piece, such as from ABS, EVA or similar material.

Along the upper region of the exterior outer sidewall 66 of the rod pocket 46 may be a notched region 76 as best shown in FIG. 6. The notched region 76 may be in the form of a slight recess or indention. The notched region 76 allows for a small gap between the longitudinal wall 52 or 58 of the interior compartment 16 or 18 and the exterior outer sidewall 66 of the rod pocket 46. As described in greater detail below, the notched region 76 may allow for easier securement of a containment strap 86 to the rod pocket 46. The notched region 76 may have securement means 74, such as a hook, loop, or Velcro®, similar to the exterior outer sidewall 66 of rod pocket 46.

The upper and lower rod holders 70 and 72 may be configured for receiving, holding and securing various types of fishing rods 12 from short ice fishing rods to long one-piece rods and rods that may be broken down into two, three, four or more pieces. As best shown in FIGS. 6 and 7A-7C, both upper and lower rod holders 70 and 72 may have an interior retaining wall 78 and 80, respectively. Separating upper rod holder 70 from lower rod holder 72 may be a divider wall 82 as best shown in FIG. 6. In the embodiment shown in the figures, the divider wall 82 has an angled configuration. The angled configuration of the divider wall 82 may allow for better economy of space within the case 10 by partially stacking the upper rod holder 70 on the lower rod holder 72 while still allowing for easy access to the lower rod holder 72. However, the divider wall 82 may have a vertical or orthogonal configuration in alternative embodiments. The upper and lower rod holders 70 and 72 may also be two separable components that are stackable and may be temporarily or removably secured using hook and loop fasteners or the like. In such an embodiment, a third rod holder (not shown) may be stacked on top of the upper rod holder 70 to hold and store an additional rod 12. The divider wall 82 may have securement means 74, such as a hook, loop, or Velcro® similar to the exterior sidewalls 66 and 68 as best shown in FIGS. 7A-7C.

As shown in FIG. 6, the interior retaining walls 78 and 80 of the upper and lower rod holders 70 and 72 may have a generally rounded shape conforming to the shape of a fishing rod; however, alternative configurations of the interior retaining walls 78 and 80 may be used. Each of the retaining walls 78 and 80 may have an upper lip 84 at one or both edges of the retaining wall 78 or 80, as best shown in FIG. 6. The upper lips 84 may facilitate maintaining the rod 12 in position once inserted into the upper and lower rod holders 70 and 72.

In order to better secure a fishing rod 12 within the upper and lower rod holders 70 and 72, containment straps 86 may be used as best shown in FIGS. 7C-7C. The containment straps 86 may be constructed from fabric, plastic, clear vinyl or other suitable material for securing rods 12 in the upper and lower rod holders 70 and 72. The containment straps 86 may also be capable of preventing fishing hooks from snagging (such as when constructed from clear vinyl) and preventing dust from getting on fishing line (such as when constructed from fabric). The straps 86 may of any suitable width. As shown in FIG. 1, the straps 86 may have the form of a conventional retaining strap; however, in alternative embodiments, the containment straps 86 may have a much larger width and even a single containment strap 86 having a width spanning substantially the entire length of the rod pocket 46 may be used.

Each containment strap 86 may include securement means 88 on one or both ends that are configured to connect to the securement means 74 on the exterior sidewalls 66 and 68 and divider walls 82 of the rod pockets 46. The securement means 88 of the containment straps 86 may also be configured to connect to securement means 74 located on the walls 52, 54, 56, 58, 60 and/or 62 of the interior compartments 42 and 44. Alternatively or additionally, the securement means 88 of containment straps 86 may be configured to connect to liner 45. The securement means 88 may consist of Velcro® or similar hook and loop fastener material, similar to securement means 74.

The containment straps 86 may also be fully or partially removable from the rod pockets 46 and/or interior compartments 42 and 44. When fully removable, as shown in FIGS. 7A-7C, both ends of the containment strap 86 includes securement means 88 that can be connected and removed from corresponding opposing securement means 74 located on the rod pockets 46 and/or walls of the interior compartments 42 and 44. As shown in FIGS. 7A-7C, the containment straps 86 may be secured at one end to the notched region 76 and then positioned to span over one or both of the rod holders 70 and 72 where the second end of the containment strap 86 may be secured to the divider wall 82, inner sidewall 68, and/or interior walls of interior compartment 42 or 44.

When only partially removable, one end of the containment strap 86 may be affixed to a sidewall 66 or 68 (or notched region 76) of the rod pocket 46 or affixed to one of the interior walls 52, 54, 56, 58, 60 or 62 of the interior compartment 42 or 44. The opposing end of the containment strap 86 may include securement means 88 that can be connected and removed from opposing securement means 74 located on the rod pocket 46 and/or interior walls of interior compartments 42 and 44 as shown in FIG. 1.

When securing a fishing rod 12 within the upper and lower rod holders 70 and 72 of the rod pocket 46, one or both ends of the containment straps 86 are removed from the rod pocket 46. The rod 12 is then placed within the upper and/or lower rod holders 70 and 72. The containment straps 86 may then be placed over the openings 90 and 92 of the upper and lower rod holders 70 and 72. The securement means 88 on the containment straps 86 may then be secured to the opposing containment means 74. In one embodiment, a containment strap 86 may be used to secure only the upper rod holder 70, as shown in FIG. 7A, and a separate containment strap 86 may be used to secure only the lower rod holder 72, as shown in FIG. 7B. In an alternative embodiment, a containment strap 86 may be used to secure both the upper and lower rod holders 70 and 72, as shown in FIG. 7C.

Multiple containment straps 86 may be placed along the length of the rod pocket 46, as shown in FIG. 1 in order to adequately secure a fishing rod 12 or similar object in the rod holders 70 and 72. When the securement means 74 are continuously provided across the length of the rod pocket 46, a user may selectively choose the locations of the containment straps 86 across the length of the rod pocket 46 when containment straps 86 are fully removable.

The rod pocket 46 may have a continuous length, as best shown in FIGS. 1, 9, and 10, or a non-continuous length, as best shown in FIG. 8. When the rod pocket 46 has a continuous length, it may comprise a single component spanning the length of the longitudinal walls 52 or 58 of the first or second interior compartment 42 or 44. When the rod pocket 46 has a non-continuous length, a plurality of non-continuous rod pocket components 94 having gaps 96 therebetween may span the length of the longitudinal side 52 or 58 of the upper or lower section storage space 42 or 44. The rod pocket components 94 and corresponding gaps 96 may be any number of lengths so long as the rod pocket can sufficiently support the rod 12.

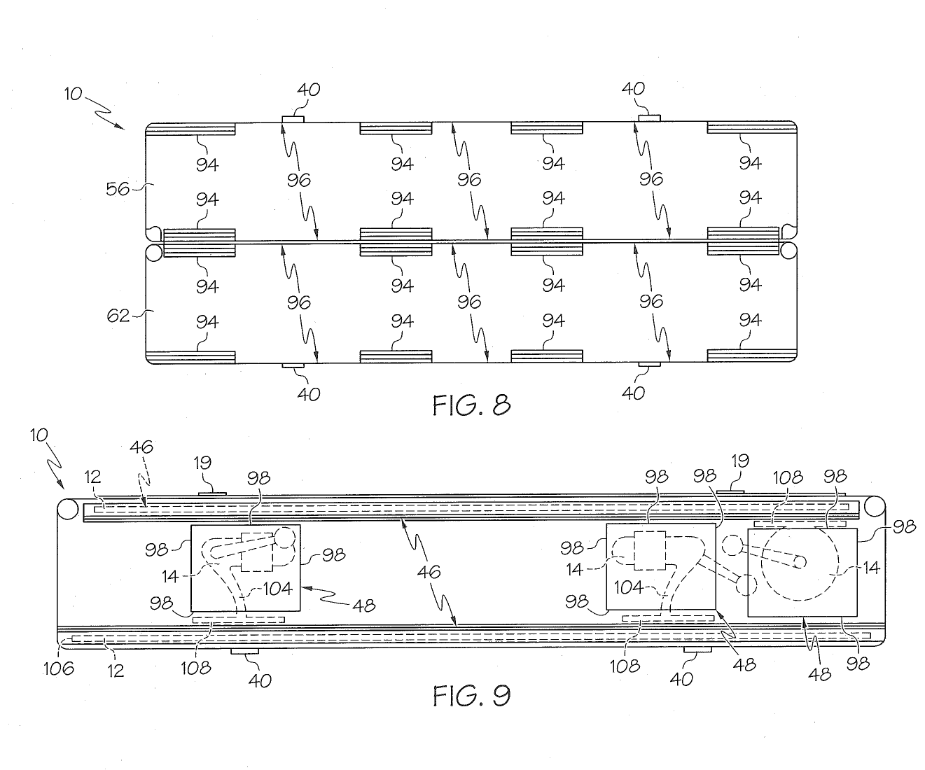

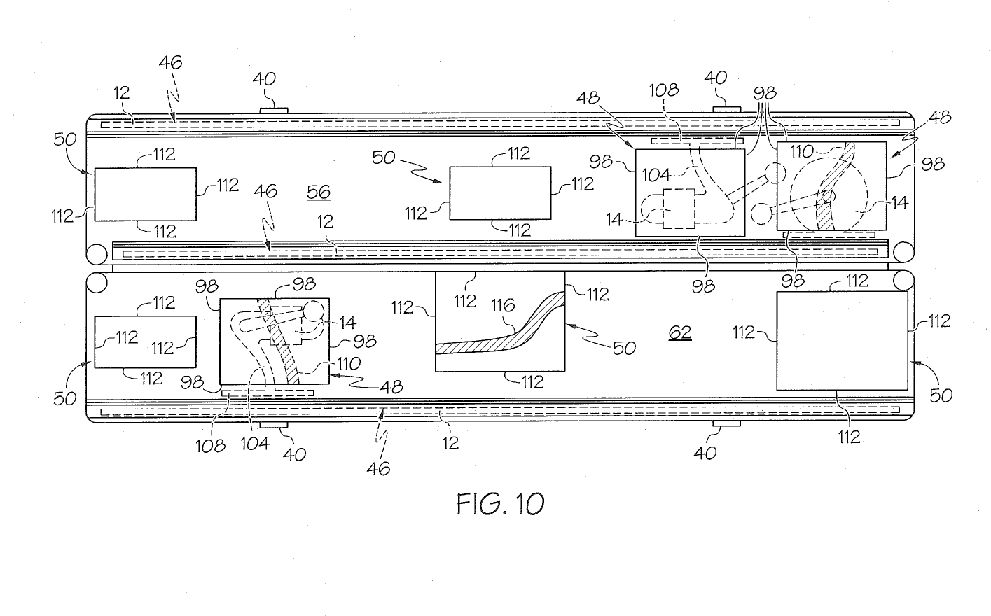

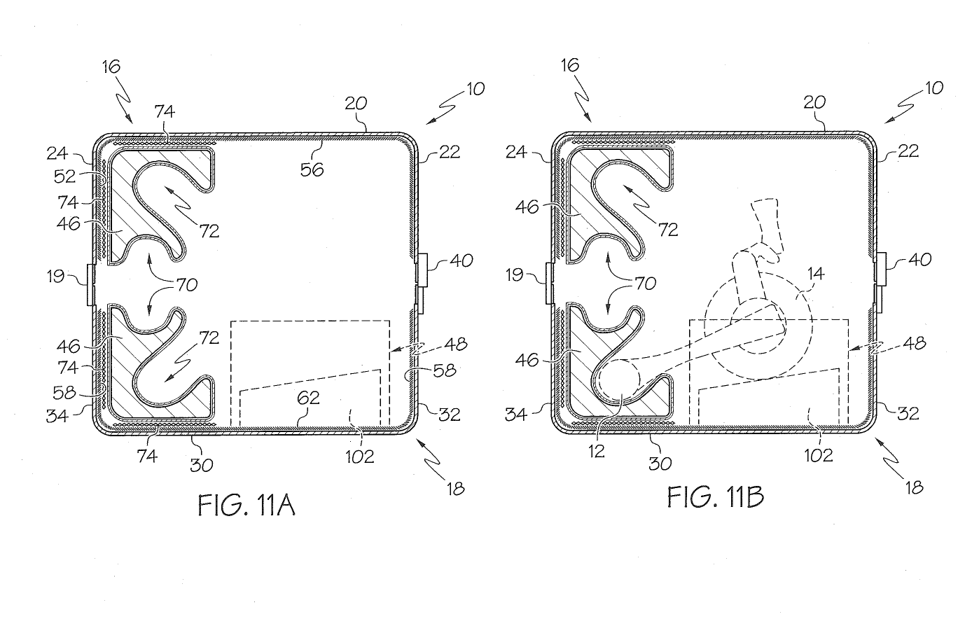

In addition to the longitudinal rod storage compartments or rod pockets 46, both the interior compartments 42 and 44 may contain one or more reel storage regions 48 as shown in FIGS. 9 and 10. Each reel storage region 48 may be sized and configured for holding one of several different types of fishing reels 14, including but not limited to, closed face spinning reels, open face spinning reels, bait-caster reels, and fly reels. The reel storage regions 48 may be generally positioned between the longitudinal walls 52 and 58 and/or adjacent rod pockets 46. The figures illustrate embodiments of the reel storage regions 48 that are generally rectangular or square; however, in alternative embodiments, the reel storage regions 48 may comprise any number of other shapes or designs. In one embodiment, the case 10 is designed without defined reel storage regions 48. In such an embodiment, the reels storage compartments 48 are created by the available or unoccupied spaces within the first or second interior compartment 42 or 44. The reel storage regions 48 may also be defined by the outer walls of the surrounding general storage compartments 50.

In one embodiment, the reel storage regions 48 include a plurality of sidewalls 98 that extend generally upward from the bottom wall 56 or 62 of the interior compartments 42 and 44 and define an open space 100 for receiving a fishing reel 14. The sidewalls 98 may be constructed from foam, plastic, metal, wood or other suitable material. In an alternative embodiment, the reel storage regions 48 are formed in the liner 45, as shown in FIG. 5, such that a negative space is formed within the liner 45 in the generally central region of the interior compartment 42 or 44. One of the sidewalls 98 (and/or liner 45) may include a recessed portion (not shown) that allows a reel 14 to remain connected to a rod 12 located in one the rod pockets 46. In an alternative embodiment, the reel storage regions 48 are simply a representative space available in the first or second interior compartment 42 or 44.

Within the reel storage region 48 may be reel positioners 102 that align and position the reel when placed in the compartment 48 and prevent the reel from being damaged during storage and transport of the case 10. The reel positioners 102 may be used to align the reel 14 both longitudinally and vertically. For example, a reel positioner 102 may be used to elevate the reel 14 such that it places the reel extension arm 104 at the same general height as the upper rod holder 70. A reel positioner 102 may also be used to place the reel 14 at a longitudinal distance from wall 54 or 60 generally equal to the distance between wall 54 or 60 and the rod reel seat 108 so that the rod 12 and reel 14 may remain attached when stored in case 10. The reel positioner 102 may also be used to prevent the reel 14 from sliding in the case 10 during transport and otherwise generally secure and protect the rod 12 and reel 14 while stored within the case.

The reel positioners 102 may be constructed from EVA, foam, plastic or similar material and act generally as a spacer between the reel 14 and the bottom of the reel storage region 48, which may be the liner 45 or the bottom wall 56 or 62 of the interior compartments 42 and 44. In one embodiment, the reel storage regions 48 are defined solely by perimeters of the reel positioners 102. In an alternative embodiment, the reel storage regions 48 are designed with sidewalls 98 and include only the reel positioners 102.

In one embodiment of the present invention, the reel storage regions 48 are affixed to the liner 45 and/or interior compartment bottom wall 58 or 62 using permanent securing means such as adhesive. The reel storage regions 48 may also be permanently affixed when defined within the liner 45.

Alternatively, the reel storage regions 48 may be selectively moveable within the interior compartments 42 and 44. When the storage compartments 48 are selectively moveable, the compartments 48 may be secured to the bottom wall 56 of the first interior compartment 42 or to the bottom wall 62 of the second interior compartment 44 using suitable securement means similar to securement means 74 and 88 previously described. Alternatively, the reel storage regions 48 may be secured to the liner 45 in place of bottom wall 56 or 62. When secured to the interior compartments 42 and 44 using removable securing means, the reel storage regions 48 may be selectively positioned within the interior compartments 42 and 44 such that the reel and corresponding rod may remain connected to one another while both stored in case 10. To accomplish this, a reel storage region 48 is placed at a distance from the rod storage compartment or rod pocket 46 that is roughly equivalent to the length of the reel extension arm 104 and placed at a distance from the transverse wall 54 of 60 of interior compartment 42 or 44 that is roughly equivalent to the distance between the base end 106 of the rod 12 and the reel seat 108 of the rod 12.

FIGS. 11A-11C illustrate zero, one, and four reels 14 with attached rods 12 loaded and stored in the case 10, according to one embodiment of the present invention. In FIG. 11A, the each shell half 16 and 18 includes a rod storage compartment or rod pocket 46 along one longitudinal wall 52 or 58. The second shell half 18 also includes a reel storage region 48 with a reel positioner 102. FIG. 11B illustrates the case 10 illustrated in FIG. 11A when the case 10 is storing a reel 14 in the reel storage region 48 with an attached rod 12 in the rod pocket 46 of the second shell half interior compartment 44. As shown in FIG. 11B, the reel storage region 48 (and reel positioner 102) is selectively positioned away from the rod pocket 46 such that the rod 12 and reel 14 may remain attached while being stored. FIG. 11C illustrates a case 10 having rod pockets 46 in both the first and second interior compartments 42 and 44, according to one embodiment of the present invention. The case 10 illustrated in FIG. 11C has two reel storage regions 48 in each interior compartment 42 and 44. To allow for attached rods 12 to be stored in the corresponding rod holders 46, the reel storage regions 48 and/or accompanying reel positioners 102 in each interior compartment 42 or 44 may have different heights, as best shown in FIG. 11C, which illustrates four reel storage regions 48 holding four reels 14 attached to accompanying rods 12 stored in the upper and lower rod holders 70 and 72 of the rod pockets 46.

The reel storage regions 48 may also be selectively positioned such that a reel storage region 48 (and reel positioner 102) in the first interior compartment 42 does not superimpose a reel storage region 48 (and reel positioner 102) in the second interior compartment 44. This allows the reels 14 to extend into the opposing first or second interior compartment 42 or 44 when both shell halves 16 and 18 or pivotally hinged together and the case 10 is in the closed position. In such an embodiment the case 10 may have a reduced overall height.

To secure a reel 14 in a reel storage region 48, fasteners 110 or other securing means may optionally be used. The fasteners 110 may be straps with hook and loop style securing means, protective netting, fabric, cushions, or other commonly available types of fasteners. The fasteners 110 may be secured to opposing sidewalls 98 of the reel storage region 48. Alternatively, the fasteners 110 may be secured to the liner 45 and/or walls 52, 54, 56, 58, 60, and/or 62 of the interior compartments 42 and 44. In an alternative embodiment, the reel storage regions 48 may include fully or partially removable lids (not shown) that secure the reels 14 within the compartments 48.

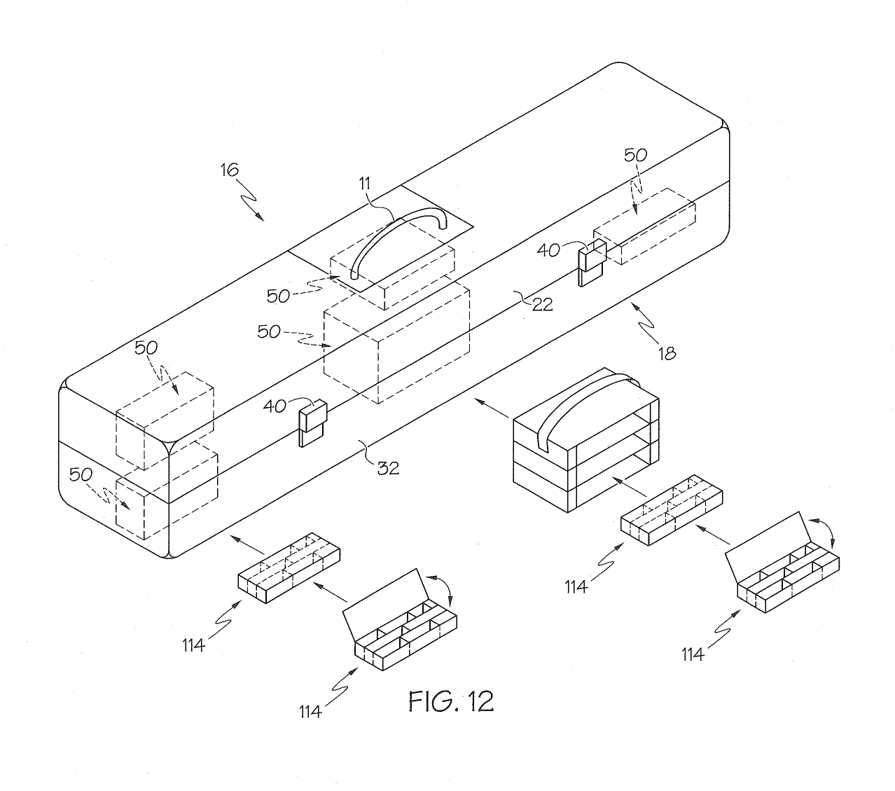

Both interior compartments 42 and 44 may also include general storage compartments 50. The general storage compartments 50 may be selectively positioned between the reel storage regions 48. The general storage compartments 50 may be used to store various types of equipment, such as fishing line, lures, bait, tool, etc. Similar to the rod storage compartments, the general storage compartments 50 may be formed in the liner 45 of the first or second interior compartment 42 or 44. The general storage compartments may also be formed from upwardly extending sidewalls 112 extending from the liner 45 and/or bottom wall 58 or 62. The sidewalls 112 may be constructed from plastic, metal, foam, wood or the like. The general storage compartments 50 may be permanently affixed to one or more of the walls 52, 54, 56, 58, 60 and 62 (or alternatively, liner 45) of interior compartment 42 or 44. General storage compartments 50 may also be temporarily affixed to the interior compartment walls 52, 54, 56, 58, 60 and 62 using temporary securing means similar to those described above, such hook and loop fasteners. By using temporary securing means, the general storage compartments 50 may be selectively positioned in, or removed from, the first and second interior compartments 42 and 44 as desired by the user. The generally storage compartments 50 may be used to hold individual storage containers 114 as shown in FIG. 12. The individual storage containers 114 may be secured within the storage compartments 50 using commonly available fasteners 116, such as containment straps, hook and loop securement means, protective netting, fabric, foam cushions, or other suitable means. The storage compartments 50 may be selectively sized and positioned such that a storage compartment 50 in the upper section storage space 42 does contact a storage compartment 50 in the lower section storage space 44 so as to prevent the case 10 from being placed in the closed position.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A storage and carrying case for fishing-related equipment, including a fishing reel and a fishing rod, the case comprising:
a first shell having a first interior compartment comprising a first bottom wall and at least one upwardly extending first longitudinal sidewall; and
a rod storage compartment extending along the at least one first longitudinal sidewall.

2. The case of claim 1 further comprising a reel storage region defined within the first interior compartment, wherein the reel storage region is positioned within the first interior compartment at a location enabling the fishing reel to be stored within the reel storage region and the fishing rod to be stored within the rod storage compartment while the fishing rod and fishing reel are attached to one another.

3. The case of claim 2, wherein the reel storage region includes a reel positioner, and wherein the fishing reel is at least partially in contact with the reel positioner when the fishing reel is stored within the reel storage region.

4. The case of claim 1, wherein the first interior compartment further comprises a first liner attached to the first bottom wall and the at least one first longitudinal sidewall.

5. The case of claim 4, wherein the rod storage compartment is defined in the first liner such that the liner and the rod storage compartment are molded as a single unitary component.

6. The case of claim 1, wherein the rod storage compartment is removably secured to the first interior compartment.

7. The case of claim 3, wherein the reel positioner is removably secured to the first interior compartment.

8. The case of claim 1 further comprising a lighting device attached to a bottom exterior panel of the first shell.

9. The case of claim 1 further comprising a padding attached to the first shell.

10. The case of claim 1 further comprising a solar panel located on the first shell and connected to a battery located in the first interior compartment.

11. The case of claim 1, wherein the rod storage compartment includes an upper rod holder with an upper opening and a lower rod holder with a lower opening, wherein the upper rod holder and the lower rod holder are separated by a dividing wall, and wherein the lower rod holder is located below, and at least partially offset from, the upper rod holder.

12. The case of claim 11, wherein the rod storage compartment further includes at least one containment strap capable of spanning over at least one of the upper opening and the lower opening.

13. The case of claim 11, wherein the containment strap includes a first end removably connected to the rod holder.

14. The case of claim 12, wherein the containment strap includes a second end affixed to at least one of the rod holder, the at least one first longitudinal sidewall, and the first bottom wall.

15. The case of claim 1 further comprising a general storage compartment for holding fishing tackle and other fishing equipment, wherein the general storage compartment is connected to at least one of the first bottom wall and the at least one first longitudinal sidewall.

16. The container of claim 1, wherein the rod storage compartment comprises:
a base and two opposing exterior sidewalls;
a first rod holder slot defining a first opening;
a second rod holder slot defining a second opening; and
a divider wall dividing the first rod holder slot and the second rod holder slot.

17. The case of claim 16 further comprising removable securement means located on the base and exterior sidewalls of the rod storage compartment for removably attaching the rod holder to the first interior compartment.

18. The case of claim 16 further comprising a containment strap having a free end with removable securement means that connect to the securement means located on the exterior sidewalls of the rod storage compartment.

19. A storage and carrying case for fishing related equipment, including a fishing reel and a fishing rod, the case comprising:
a first outer shell half having a first interior compartment comprising a bottom wall and at least one upwardly extending sidewall;
a second outer shell half having a second interior compartment comprising a bottom wall and at least one upwardly extending sidewall;
a first rod storage compartment comprising a base, two exterior sidewalls, an upper rod holder and a lower rod holder, wherein the first rod storage compartment is connected to the bottom wall and one of the longitudinal walls of the first interior compartment or the second interior compartment, and wherein the first rod storage compartment spans substantially the entire length of the longitudinal sidewall it is connected to;
a first reel storage region including a reel positioning device and a securement means at least partially removably connected to at least one of the reel positioning device, the bottom wall of the first interior compartment, and the bottom wall of the second interior compartment; and
a first tackle storage compartment comprising a plurality of sidewalls connected to the bottom wall of the first interior compartment or the second interior compartment and a securement means at least partially removably connected to one of the plurality of sidewalls;
wherein the first reel storage is located a first distance from the first rod storage compartment that is substantially equal to the distance of the extension arm of the fishing reel, and wherein the first reel storage region is located a second distance from a base end of the fishing rod that is substantially equal to the distance between a reel seat of the fishing rod and the base end of the fishing rod;
wherein the first shell half and second shell half are connected together by a hinge capable of allowing the case to transition from an open position to a closed position where the first shell half is located on top of the second shell half.

20. The case of claim 19 further comprising:
a second rod storage compartment comprising a base, two exterior sidewalls, an upper rod holder and a lower rod holder; and
a second reel storage region including a reel positioning device and a securement means at least partially removably connected to at least one the reel positioning device and the bottom wall of the second interior compartment;
wherein the second rod storage compartment is connected to the bottom wall and one of the longitudinal sidewalls of the second interior compartment;
wherein the first rod storage compartment and first reel storage region are located in the first interior compartment;
wherein the first reel storage region does not substantially overly the second reel storage region when the case is in the closed position.
